(19) United States
(12) Patent Application Publication
(10) Pub. No.: US 2013/0248042 A1
(43) Pub. Date: Sep. 26, 2013

(54) METHODS AND APPARATUSES FOR REPAIRING A CONDUIT

(71) Applicant: John A. Charest, Colchester, CT (US)

(72) Inventor: John A. Charest, Colchester, CT (US)

(73) Assignee: Altran Solutions Corp., Boston, MA (US)

(21) Appl. No.: 13/428,761

(22) Filed: Mar. 23, 2012

(51) Int. Cl. F16L 9/14; F16L 55/163

(52) U.S. Cl. 138/141; 138/98

(57) ABSTRACT

Methods and apparatuses relate to repairing a conduit having a defect and providing the conduit with structural support. A support member may be positioned along the inner surface of a conduit covering a defect. A sealing member may be disposed along a periphery of the support member so as to provide an obstruction to fluid flow between an outer surface of the support member and the inner surface of the conduit. One or more retaining members may apply a suitable pressure to the sealing member and support member to maintain obstruction to fluid flow between the interior and the exterior of the conduit. The support member may provide the repaired conduit with a greater degree of structural integrity and strength at the site of the defect than would otherwise be available.

### BACKGROUND

1. Field

Aspects of the present disclosure relate to a method and apparatus for repairing a conduit, such as a pipe. The method and apparatus may be used to repair a conduit so as to obstruct leakage arising from a defect while also providing structural support to the conduit.

2. Discussion of Related Art

Conduits, such as those used for industrial piping, are used to transport fluids for any number of applications, such as for wastewater treatment, nuclear/chemical/power plant operations, manufacturing facilities, etc. In several instances, industrial pipes are made from ductile or cast iron, or steel. At times, fluids that travel through such conduits are caustic and can contribute to defects in the structure of the conduit. After prolonged and substantial use, it is common for conduits to become worn down or to deteriorate (e.g., creating cracks, holes, etc.) which may give rise to leakage in various locations of the conduit. In several instances, preferential deterioration (e.g., corrosive attack, erosion, etc.) may occur at particular locations of a piping conduit, such as at straight sections, welded regions or transitional regions, for example, flanged joints, elbows, tees, and bell and spigot connections.

FIGS. 1A and 1B illustrate a conventional conduit 2 having a cylindrical wall 4 that defines and extends circumferentially around an internal lumen. As shown in FIG. 1B, a defect 6 has occurred in the wall 4, extending through the wall thickness. Accordingly, fluid may leak through the defect 6 between the interior lumen of the conduit and the exterior of the conduit, or vice versa. That is, fluid traveling through the lumen of the conduit may leak through the defect toward the exterior, or fluid from the exterior of the conduit may travel through the defect and into the internal lumen.

Once a conduit is damaged to the point where leakage occurs, or may potentially occur, the conduit will require repair such as by the application of a seal, welding the defect shut with a patch of iron or steel, or covering the conduit from the exterior, for example, with a clamping device. When deterioration is extensive (e.g., evidenced by a high volume of fluid leakage, or imminent leakage, between the interior and exterior of the conduit), substantial sections of the conduit may require a significant amount of welding, and oftentimes replacement of those sections entirely. However, in many cases, and particularly for industrial-type piping, such conduits are buried underneath the ground, presenting challenges to their repair and replacement.

### SUMMARY

The inventors have recognized and appreciated a need to develop improved methods and apparatuses for repairing defects arising within a conduit while also providing the conduit with structural support. In some embodiments, a defect in a conduit is covered from within the internal lumen of the conduit by a support member, such as a steel plate. In some cases, the support member may be shaped or adaptable to be positioned along the inner surface of the wall of the conduit over the defect (e.g., crack, opening, hole, etc.). Once suitably positioned, the support member may be covered by a sealing member, such as a flexible elastomeric gasket, where the sealing member may have a peripheral region that is positioned along the periphery of the support member. The sealing member may cover the periphery of the support member in a manner that obstructs fluid from flowing between the outer surface of the support member and the inner surface of the conduit. For example, a peripheral region of the sealing member may form a seal with an inner surface of the conduit wall around the support member.

In some embodiments, one or more retaining members (e.g., retaining/support bands) are positioned along the inner surface of the sealing member applying pressure to both the sealing member and the support member against the inner surface of the conduit. The applied pressure from the retaining member(s) may facilitate the obstruction of fluid flow via the defect between the interior and the exterior of the conduit.

Additionally, the support member provides structural support at the site of the defect, substantially resisting net pressure that may be present in proximity to the defect. Accordingly, with the support member in place, the repaired conduit exhibits a greater degree of structural integrity and strength at the site of the defect, and is more likely to withstand large pressure differentials between the interior and the exterior of the conduit than would otherwise be possible absent the support member. That is, without the support member in place, when a substantial pressure difference arises between the interior and the exterior of the repaired conduit, it would be less likely for the sealing member to maintain a seal at the site of the defect, resulting in a failed repair.

The repair apparatus may be installed at the site of the defect from within the interior lumen of the conduit in accordance by any suitable method. In some embodiments, a support member is positioned over the defect along the circumference defined by the inner surface of the conduit. In some cases, the support member is a relatively thin steel plate that is flexible enough to conform to the shape of the inner surface wall of the conduit and, in some cases, may overlap with itself. A sealing member (e.g., rubber gasket) may be positioned over the support member, inward with respect to the support member, so as to cover the periphery of the support member in a manner that obstructs fluid from flowing between the outer surface of the support member and the inner surface of the conduit. One or more retaining members may be expanded against the sealing member so as to apply outward pressure to both the sealing member and the support member toward the inner surface of the conduit. Such a repair arrangement may significantly increase the life of the conduit, avoiding conventional repair techniques, such as welding, replacing portions of the conduit or adding support material on the exterior of the conduit.

In an illustrative embodiment, an apparatus for repairing a conduit is provided. The apparatus includes a support member constructed and arranged to be positioned along an inner surface of the conduit. The apparatus also includes a sealing member adapted to be positioned along at least a periphery of the support member so as to provide an obstruction to fluid flow between a portion of an outer surface of the support member and a portion of the inner surface of the conduit.

In another illustrative embodiment, a conduit assembly is provided. The conduit assembly includes a conduit having an inner surface defining a lumen of the conduit; a support member disposed along the inner surface of the conduit; and a sealing member disposed along at least a periphery of the support member so as to obstruct fluid flow between a portion of an outer surface of the support member and a portion of the inner surface of the conduit.

In a further illustrative embodiment, a method of repairing a defect in a conduit is provided. The method includes positioning a support member along an inner surface of the conduit; and positioning a sealing member along at least a periphery of the support member so as to obstruct fluid flow between a portion of an outer surface of the support member and a portion of the inner surface of the conduit.

Various embodiments of the present invention provide certain advantages. Not all embodiments of the invention share the same advantages and those that do may not share them under all circumstances.

Further features and advantages of the present invention, as well as the structure of various embodiments of the present invention are described in detail below with reference to the accompanying drawings.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. Various embodiments of the invention will now be described, by way of example, with reference to the accompanying drawings, in which:

FIG. 1A is a side view of a conventional conduit having a defect;

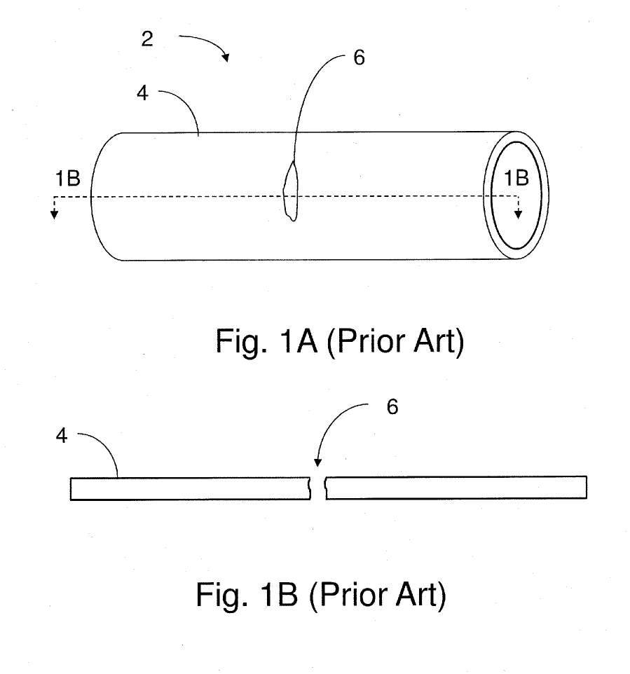

FIG. 1B is a cross-sectional view of the conduit of FIG. 1A;

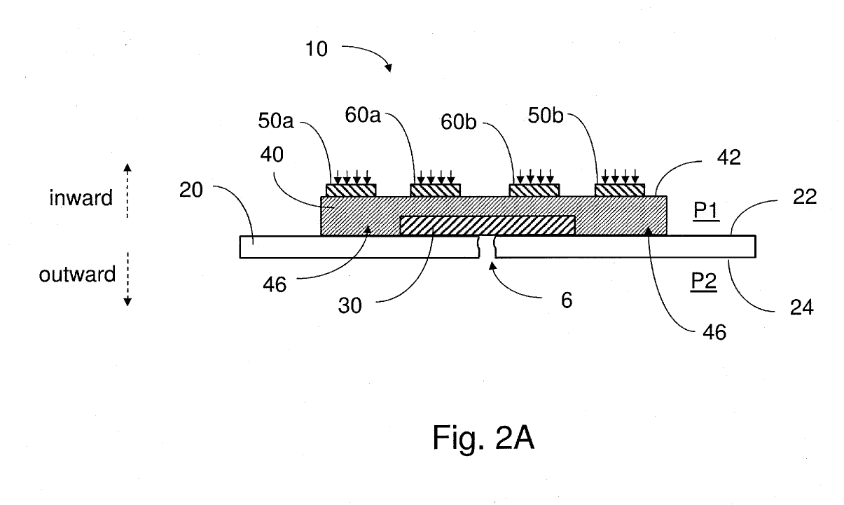

FIG. 2A is a cross-sectional view of a repaired conduit in accordance with some embodiments;

FIG. 2B is a plan view of a repaired conduit in accordance with some embodiments;

FIGS. 3A-3C are cut off perspective views of a repaired conduit in accordance with some embodiments;

FIG. 4 is a section view of a repaired conduit in accordance with some embodiments;

FIGS. 5A-5B is a section view of a sealing member and a portion of a conduit in accordance with some embodiments;

FIGS. 6A-6B are section views of a sealing member, a retaining member and other components in accordance with some embodiments;

FIG. 7 is a cross-sectional view of a repaired conduit in accordance with some embodiments;

FIG. 8 is a cross-sectional view of another repaired conduit in accordance with some embodiments; and

FIG. 9 is a cross-sectional view of yet another repaired conduit in accordance with some embodiments.

### DETAILED DESCRIPTION

The present disclosure relates to the repair of a conduit (e.g., for industrial-type piping) having a defect while also providing structural support to the conduit. In some embodiments, a support member (e.g., stainless steel plate) covers the defect from within the internal lumen of the conduit. A sealing member (e.g., flexible material such as elastomeric rubber), in turn, covers the support member from within the internal lumen of the conduit. When suitably positioned, at least a portion of the sealing member may extend around the periphery of the support member. One or more retaining members may be positioned from within the internal lumen of the conduit over the inner surface of the sealing member. The retaining member(s) may be expanded outward to apply a pressure to both the sealing member and the support member against the inner surface of the conduit. The combination of the support member and the sealing member both covering the defect and pressing outwardly against the inner surface of the conduit, in some embodiments, forms a seal that prevents fluid flow between the interior lumen and the exterior of the conduit. It can be appreciated that other arrangements and configurations for repairing a conduit while also providing structural support to the repaired conduit may be possible.

In cases where only a sealing member (e.g., sheet of rubber) is positioned within the internal lumen of the conduit to cover the defect, without the presence of a support member providing a sufficient amount of structural integrity, the pressure within the interior lumen of the conduit (e.g., hydrodynamic, hydrostatic) may build up to such a degree that the sealing member fails. For example, upon excessive wear or pressure build up, the sealing member may develop a slight opening (e.g., crack, hole) or may be undesirably pushed through the defect, breaching the pressure boundary of the conduit altogether. Alternatively, if the pressure within the lumen of the conduit at the defect site is substantially less than the pressure immediately exterior to the conduit, the sealing member may be undesirably pushed inward toward the interior of the conduit, also causing subsequent failure repaired conduit.

The support member may provide added structural support at the site of the defect, for example, to provide pressure boundary integrity. In some embodiments, the support member is a sheet plate that covers the defect from within the internal lumen of the conduit and extends along an entire circumference defined by the inner surface of the conduit. Accordingly, a support member that extends along the entire circumference of the inner surface of the conduit, when appropriately installed, may present less of a risk of exposure of the defect than a support member that does not extend along the entire circumference of the inner surface of the conduit, as the chances that the support member is displaced in a direction (e.g., a transverse direction perpendicular to the longitudinal direction of flow in the conduit) past the defect is small.

The present disclosure relates to solutions for repairing a defect in a conduit which do not involve replacement of sections of the conduit or repair of the conduit by welding, or similar methods, as are conventionally practiced. Rather, replacement or substantial mechanical alteration of the conduit is not required, allowing for a greater degree of flexibility and ease of repair. As such, defects in a conduit may be readily and quickly repaired, minimizing overall disruption that may be caused by replacement or welding of sections of the conduit. Such a repair apparatus may also be temporary in nature as the components (e.g., support member, sealing member, retaining member(s)) can be removed, or replaced, as desired. Repairing the conduit from the interior using repair methods and apparatuses described herein may also avoid the often required expensive procedure of digging to reach the conduit at the defect site. Further, repairing from the interior of the conduit may also allow for the various components (e.g., support member, sealing member) to be extended for long lengths along the conduit so as to repair and provide structural support at multiple defect sites having arisen within the conduit.

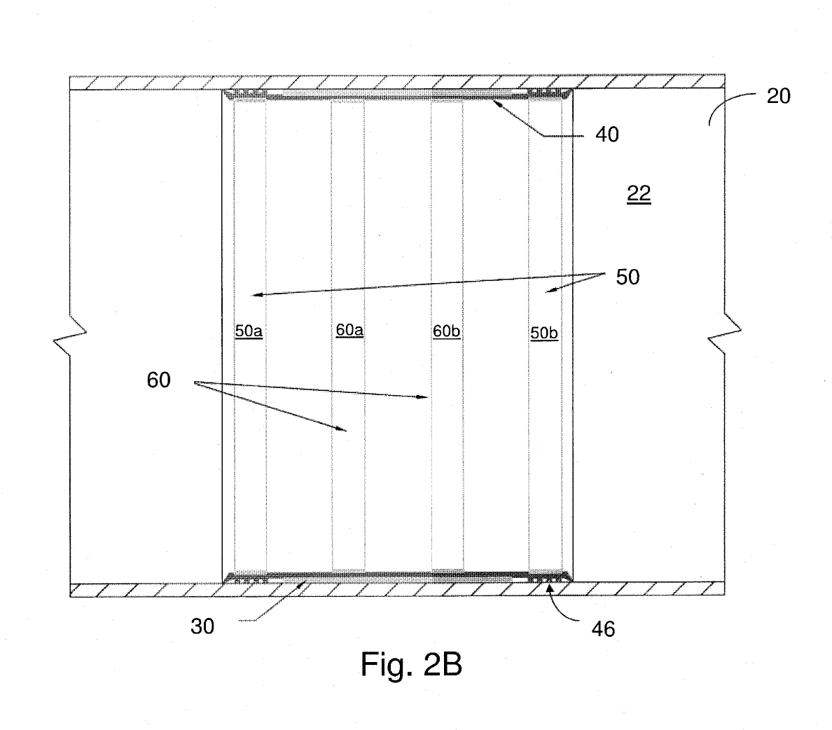

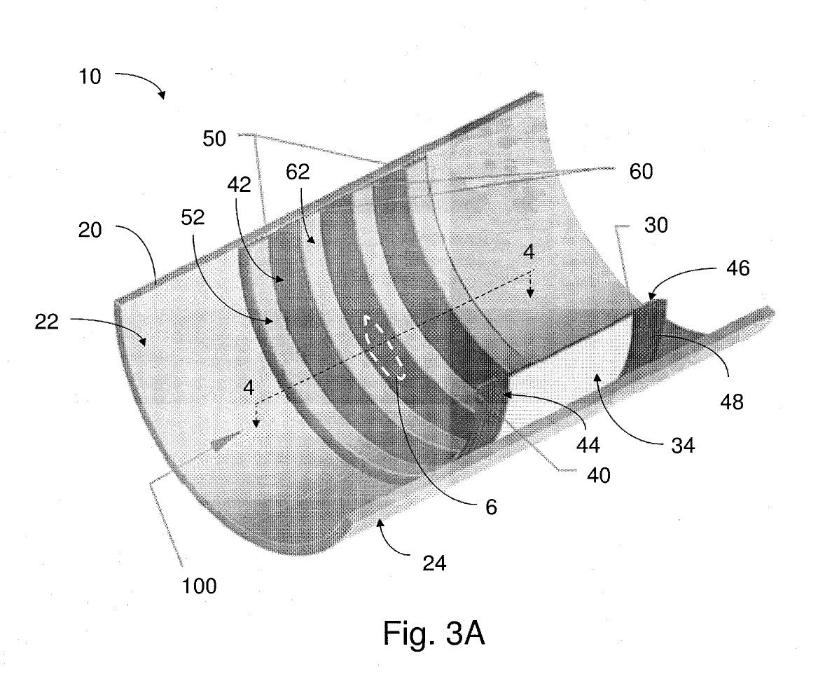

FIGS. 2A and 2B depict illustrative embodiments of various portions of a conduit 10 having a defect 6 that runs through the conduit wall 20 where a suitable repair apparatus has been installed. FIG. 2A shows the wall 20 having an inner surface 22 and an outer surface 24, defining the pressure boundary between the interior pressure P1 that is present within the lumen of the conduit (e.g., arising from static or dynamic fluid) and the exterior pressure P2 that is present external to the conduit. In FIG. 2A, inward and outward directions relative to the conduit are depicted by the dashed arrows. As such, inward generally refers to a radial direction toward the interior lumen of the conduit and outward generally refers to a radial direction toward the exterior of the conduit.

A support member 30 is positioned along the inner surface 22 of the wall 20 within the interior lumen of the conduit. As shown in FIGS. 2A and 2B, the support member 30 contacts the inner surface 22 of the conduit wall; however, it can be appreciated that not all embodiments of the present disclosure requires such contact. That is, the support member 30 may be spaced from the inner surface 22 of the conduit wall; for example, a small air gap or an intermediate layer such as a rubber gasket or film (e.g., protective layer, shim) may be disposed between the support member and the conduit wall. When the repair apparatus is appropriately installed, the support member provides structural integrity to the repaired conduit and is able to assume a substantial amount of mechanical load arising from the pressure differential (e.g., difference between P1 and P2) that may exist between the interior lumen and the exterior of the conduit. In some embodiments, the support member provides structural integrity to the repaired conduit for pressure differentials between the interior and exterior of the conduit that are greater than 5 psi, greater than 10 psi, greater than 15 psi, or greater than 20 psi. For instance, in cases where only a sealing member were placed in position over the defect, in the absence of a suitable support member, the sealing member itself could fail when exposed to pressure differentials between the interior and exterior of the conduit of less than 10 psi, or even less than 5 psi.

A sealing member 40 is positioned over the inner surface of the support member 30. The peripheral regions 46 of the sealing member extend along the periphery of the support member so as to provide a seal that impedes fluid flow between the outer surface of the support member and the inner surface 22 of the conduit wall. For instance, a portion of the outer surface of the peripheral region 46 may contact an appropriate region of the inner surface of the conduit to form a seal that obstructs fluid from flowing past the sealed region of contact. Accordingly, fluid within the lumen of the conduit is impeded from flowing through the defect 6 toward the exterior of the conduit, or vice versa.

The sealing member may include any material appropriate for forming and maintaining a seal to repair leakage arising from a defect in an industrial conduit. The sealing member may include materials such as ethylene propylene diene monomer (EPDM) rubber, nitrile, nitrile/polyvinyl chloride, butyl-nitrile, silicone, polyimide, polyurea, polyurethane, polyethylene, or other flexible or elastomeric materials. The material selected for incorporation in the sealing member may depend on a number of factors, such as the ability to withstand degradation due to continued exposure to the process fluid flowing through the conduit and to extreme temperatures which the materials may also undergo. In some embodiments, the sealing member is manufactured from an extruded elastomeric sheet that may or may not be vulcanized so as to form a suitable shape and size. In some embodiments, the sealing member includes one or more reinforcing liners/layers to provide additional structural strength and resistance to deterioration over time. The sealing member may incorporate other types of materials, for example, flexible materials that have elongation properties that may be appropriately adjusted, such as thermoplastics, thermoset polymers, elastomers, or combinations thereof.

Retaining members 50a, 50b, 60a, 60b are positioned along the inner surface 42 of the sealing member 40, providing an outward compressive pressure to the sealing member 40 and the support member 30, as depicted by the solid arrows. The retaining members 50a, 50b disposed at the periphery apply outward compressive pressure directly to the sealing member 40 at the peripheral regions 46. The retaining members 60a, 60b disposed closer to the defect are substantially aligned with the support member 30 and also apply outward compressive pressure directly to the sealing member 40. By pushing appropriately in an outward direction against the sealing member 40, the support member 30 and the sealing member are positioned firmly in place against the inner surface of the conduit so as to cover the defect 6, forming a seal that provides a barrier to leakage through the defect between the interior and exterior of the conduit, and providing a suitable degree of structural integrity at the pressure boundary.

The support member and/or retaining member(s) may include an appropriate material. In some embodiments, the support member and/or retaining member(s) include a metal alloy, stainless steel (e.g., Al-6XN, N08367, 304, 316L, duplex), carbon steel (e.g., A36, 1020), shape-memory alloys/steels, titanium, other metallic materials, polyethylene, carbon fiber, or any other appropriate material having sufficient strength to withstand loads commonly experienced by the conduit (e.g., due to hydrodynamic or hydrostatic forces within the interior lumen of the conduit) as well as loads induced when retaining members are radially expanded. For example, in some cases, the yield strength of materials that may be incorporated into the support or retaining member(s) may range between about 20,000 and about 100,000 psi, or between about 25,000 and about 65,000 psi. The support and/or retaining member(s) may incorporate other types of materials.

In some embodiments, all materials (e.g., support member, sealing member, retaining member(s), other components) provided in the repair system are highly corrosion resistant. For example, such materials may be utilized in Nuclear Power plant Class 3 Service Water piping systems.

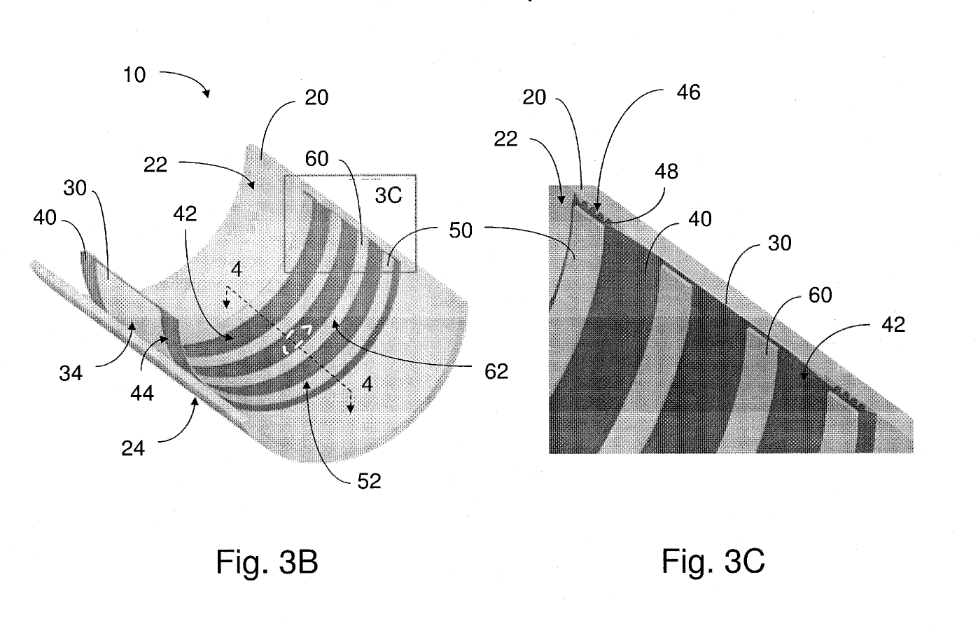

FIGS. 3A-3C show an illustrative embodiment of various portions of a substantially cylindrical conduit 10 having the repair apparatus installed within the lumen of the conduit so as to repair the defect 6 depicted by the dashed lines as well as provide added structural support to the repaired conduit. The conduit 10 includes a wall 20 having an inner surface 22 that defines the internal lumen through which fluid flows in the conduit, for example, in a direction 100. As described above, the inner surface 22 and outer surface 24 of the wall define the pressure boundary between fluid pressure within the lumen of the conduit and the pressure external to the conduit.

A support member 30 is positioned along the arcuate inner surface 22 of the conduit wall 20 substantially conforming to the cylindrical shape defined by the inner surface. In some embodiments, the support member is a steel plate having a flexibility that allows for partial or complete extension along the entire circumference of the inner surface of the wall where the defect is located; and the support member covers the defect. The outer surface 34 of the support member may be in contact with the inner surface 22 of the conduit wall. In some cases, the support member is longer than the cylindrical circumference defined by the inner surface of the wall, resulting in portions of the support member overlapping one another.

A sealing member 40 having an inner surface 42 and an outer surface 44 is positioned over the inner surface of the support member 30 and along the periphery of the support member. In some embodiments, the outer surface 44 of the sealing member is in contact with the inner surface of the support member and the inner surface of the conduit wall (i.e., at the peripheral region 46).

Retaining members 50, 60 having respective inner surfaces 52, 62 are positioned along the inner surface 42 of the sealing member 40 and are in contact with the sealing member. In some embodiments, each of the support member 30, sealing member 40 and retaining members 50, 60 extend through the entire perimeter (e.g., circumference) defined by the inner surface of the conduit where the defect is located. Accordingly, the retaining members 50, 60 may be radially expanded so as to press outwardly against the sealing member and the support member forming a seal against the inner surface of the wall of the conduit at locations surrounding the defect.

Methods and apparatuses described herein for repairing defects and providing structural support may be applicable for conduits having any suitable diameter. For instance, repair methods and apparatuses in accordance with the present disclosure are contemplated for conduits having diameters between about 2 inches and about 240 inches, between 100 inches and 220 inches, between 192 inches and 216 inches, between 4 inches and 144 inches, between 20 inches and 36 inches, or between 30 inches and 36 inches. In some embodiments, conduits may be large enough for an individual (e.g., repairperson) to enter and guide the process of installing the repair apparatus.

The peripheral region 46 shown in FIGS. 2B, 3A and 3C disposed adjacent to and along the periphery of the support member 30 includes a number of ridges 48 suitably spaced from one another that facilitate the sealing member in forming a seal with the inner surface of the conduit. In some embodiments, a peripheral region 46 having a relatively high surface area may provide for the sealing member to be appropriately secured to the inner surface of the conduit, for example, to form a suitable seal and to maintain stability of the sealing member while accommodating static or dynamic variations in the conduit. The ridges 48 of the peripheral region 46 may include a dovetail-like shape that increases the surface area of contact between the sealing member and the inner surface of the conduit. Though, in some cases, a peripheral region 46 with a block-type outer surface that runs flush against the inner surface of the conduit wall, without added structural features (e.g., ridges, depressions) such as that shown in FIG. 2A, may also be suitable for forming an appropriate seal with the inner surface of the conduit. The peripheral region 46 may comprise any suitable shape. For example, the peripheral region may have structural features that exhibit a grid-like or checkerboard type structure, giving rise to an increased surface area for the sealing region (e.g., peripheral region) of the sealing member to make contact with the conduit around the support member.

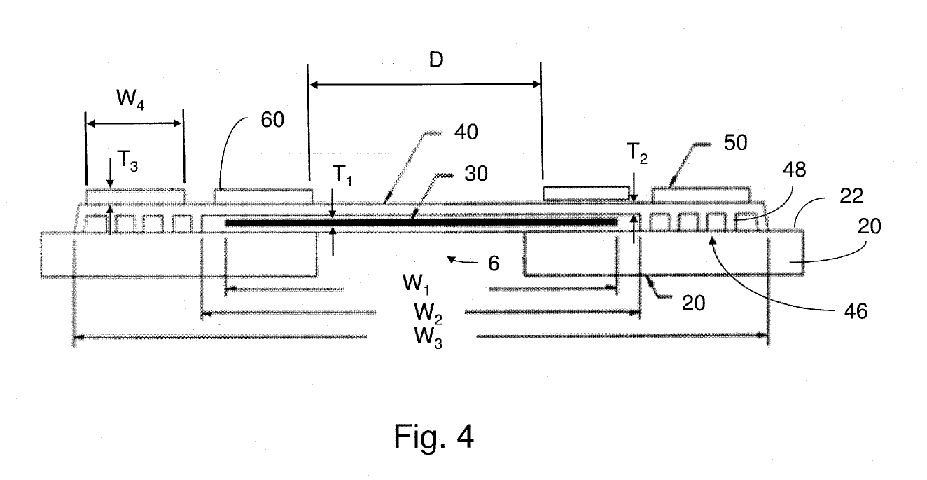

FIG. 4 illustrates a cross section of the embodiment of FIGS. 3A-3C. Similar to FIG. 2A, the conduit 20 has a defect 6 that is covered by a support member 30 which is disposed in close proximity (e.g., in contact) with the inner surface 22 of the conduit.

The support member 30 may have any suitable width W₁ and thickness T₁. In some embodiments, the width W₁ of the support member is between about 5 inches and about 25 inches, between about 10 inches and about 20 inches, or more preferably between about 13 inches and about 15 inches. In some cases, the width W₁ of the support member is such that opposite ends of the support member extend laterally at least 2 inches past the defect on each side of the defect. In some embodiments, the thickness T₁ of the support member is between about 0.01 inches and about 0.1 inches, between about 0.03 inches and about 0.8 inches, or more preferably between about 0.05 inches and about 0.7 inches. In some embodiments, repair apparatuses may incorporate support members having dimensions in accordance with the size of the conduit; for instance, the larger the conduit, due to increased stresses that may arise in the conduit, the larger/thicker the support member may be appropriate. As an example, a support member having a 1/16 inch thickness T₁ may be suitable for repairing a conduit having an 8 inch diameter; while a support member having a 3/16 inch thickness T₁ may be suitable to repair a conduit having a 16 inch diameter.

Portions of the sealing member 40 may have any appropriate dimensions. For example, the width W₂ of the sealing member between peripheral regions 46 may be between about 5 inches and about 20 inches, or more preferably between about 10 inches and about 18 inches. The width of a peripheral region 46 itself on one side of the sealing member may be between about 1 inch and about 10 inches, or more preferably between about 2 inches and about 5 inches. Accordingly, the width W₃ extending completely across the sealing member may be between about 10 and about 30 inches, or more preferably between about 10 and about 20 inches. In some embodiments, the thickness T₂ of the sealing member at the region closest to the support member and between peripheral regions 46 is between about 0.1 inches and about 1 inch, or more preferably between 0.2 inches and about 0.5 inches.

Retaining members 50, 60 may also have any suitable width W₄ and thickness T₃ and may vary appropriately between retaining members. For instance, retaining members 60 that are positioned closer to the defect 6 and disposed directly over both the sealing member 40 and support member 30 may be wider or thicker than retaining members 50 positioned closest to the peripheral regions 46 of the sealing member; though, the opposite may be true, that is, the retaining members 50 may be wider or thicker than retaining members 60. Or, all retaining members of the repair apparatus may have a substantially similar thickness and/or width. In some embodiments, the width W₄ of a retaining member 50, 60 is between about 1 inch and about 20 inches, between about 1 inch and about 10 inches, or more preferably between about 1 inch and about 5 inches. In some embodiments, the thickness T₃ of a retaining member 50, 60 is between about 0.01 inches and about 1.0 inch, or more preferably between about 0.1 inches and about 0.5 inches.

Retaining members 60 positioned in closest proximity to the defect 6, while also located on opposite sides of the defect, may be disposed an appropriate distance D apart. In some embodiments, the distance D between retaining members 60 is between about 1 inch and about 10 inches, or more preferably between about 3 inches and about 5 inches. In some embodiments, the distance D between retaining members 60 is such that the retaining members are positioned at least two inches laterally away from the defect. In such cases, it may be beneficial to have retaining members positioned a suitable distance laterally from the defect so as not to accumulate undue stress in the vicinity of the defect when the repair apparatus is deployed. However, in other embodiments, and as illustrated further below, a retaining member extends completely across the defect.

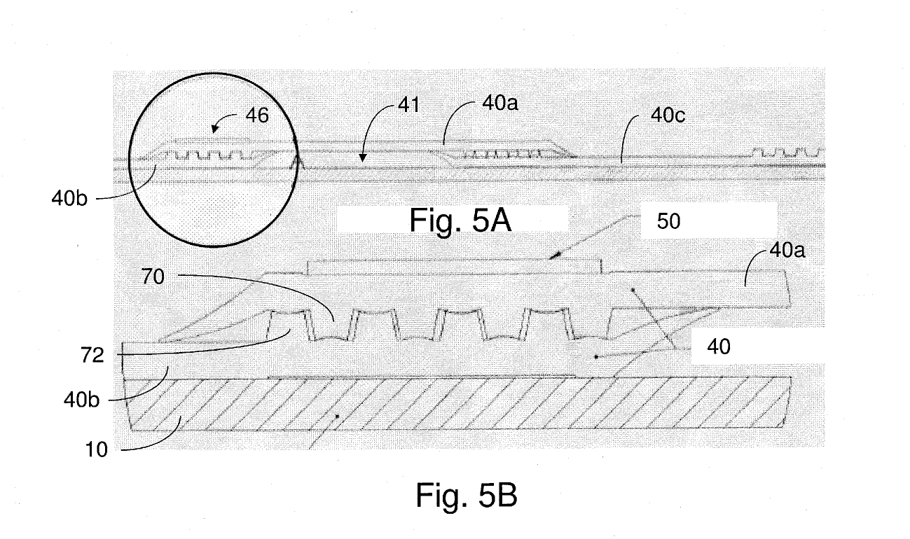

In some embodiments, as shown in FIGS. 5A and 5B, the sealing member 40 may include a number of sealing sub-members 40a, 40b, 40c engaged in an interlocking arrangement in a manner that creates a space 41. FIG. 5A illustrates sealing sub-members 40a, 40b, 40c to be formed of a substantially similar construction where sub-member 40a is engaged at its peripheral regions 46 with respective peripheral regions of sub-members 40b, 40c to form the larger sealing member 40; thus, a space 41 underneath sub-member 40a is provided within which a support member may positioned. In some cases, such an arrangement may provide for the overall repair and support apparatus to be installed in a quick and simple manner. For instance, rather than having to install a single-piece sealing member, which can be large and bulky, portions of the sealing member may be positioned within the conduit in a more manageable way. Sealing sub-members 40b, 40c may be appropriately placed and adhered (e.g., with an adhesive bond) to the inner surface of the conduit 10 (along with the support member). Sub-member 40a may be placed into interlocking engagement at its peripheral regions with sub-members 40b, 40c.

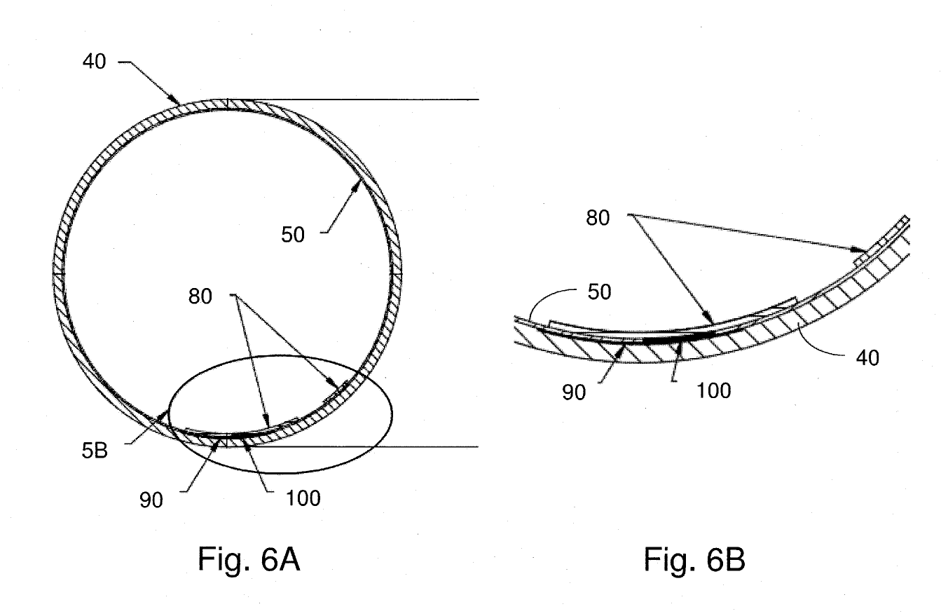

FIGS. 6A and 6B illustrate a cross section of a sealing member 40 and a retaining member 50 where the retaining member exerts a radially outward pressure against the sealing member. One or more suitable push tabs 80, shims 90 and/or wedges 100 may be provided to accommodate expansion of the retaining member 50 against the sealing member 40 and to maintain a suitable radially outward pressure throughout the installed repair apparatus.

Shims 90 may be used to protect the sealing member 40 at various locations as retaining members are expanded. In some cases, the shims are bent slightly to match the internal curvature of the sealing member. Push tabs 80 are provided as regions where a suitable pressure application instrument may engage with the retaining members of the repair apparatus so as to suitably provide radially outward expansion. For example, a hydraulic expansion tool may come into contact with the push tabs 80 so as to apply compressive pressure in a radially outward direction on to the retaining members. Due to this outward compressive pressure, a suitable amount of pressure loading is transferred to the sealing member and the support member. Retaining members may be appropriately expanded and re-expanded (e.g., after a suitable period of time to account for creep effects of the sealing member). Once creep effects are accounted for, a wedge 100 having an appropriate size and shape may be inserted between the sealing member 40 and the retaining member 50. The wedge may serve to maintain a desirable amount of outward pressure from the retaining member(s) on the sealing member to form and preserve the seal.

Variations in different aspects of the conduit, such as roundness of the conduit, diameter of the conduit, dynamic displacement of the conduit itself, sealing requirements and other tolerance concerns may be present. Accordingly, a number of components (e.g., push tabs, shims, wedges) may be used in cooperation with various features (e.g., sealing member, retaining member(s), support member) of the repair apparatus. In some embodiments, push tabs, shims or wedges have characteristics (e.g., dimensions) that are appropriate for maintaining the repair apparatus in suitable engagement with the conduit. For example, push tabs may be useful for expanding the retaining member(s) radially outward against the sealing member and support member. Shims or wedges may be useful for the retaining member(s) to apply suitable pressure to the sealing member so as to maintain a seal around the periphery of the support member, obstructing fluid flow between an outer surface of the support member and an inner surface of the conduit.

Repair apparatuses and methods in accordance with the present disclosure may be utilized at any suitable region of a conduit, such as at straight sections, elbows or tees (which may involve appropriate molding of parts) of the conduit. While repair apparatuses and methods are contemplated for conduits having a defect which may give rise to leakage in the conduit, for some embodiments, a suitable repair apparatus may be installed within the interior lumen of a conduit prior to the formation of a defect, for preventative maintenance purposes.

Various parts of the repair apparatus, including support member(s), sealing member(s) and retaining member(s) may be manufactured or modified into appropriately specific shapes for specific applications. Accordingly, conduits with circular, oval, rectangular or any other appropriately shaped cross sections are all within the scope of the present disclosure.

Systems and methods described herein may be used for any appropriate application or industry where conduits and piping is used. That is, pressured conduits implemented for all possible uses, including but not limited to, wastewater, chemical, nuclear, water treatment, process industry and power piping applications are contemplated to be within the scope of the present disclosure. In some embodiments, conduits are used in a piping system designed in accordance with the requirements of ANSI B31.1, 1967 Edition, and ANSI/AWWA C115/A21.15 involving ductile or cast iron.

Conduits having a notable defect may be repaired in accordance with any suitable technique and will now be described with respect to various embodiments (e.g., the repaired conduit illustrated in FIGS. 3A-3C). Once the defect area is identified, relatively low areas of the conduit wall and gaps in close proximity to the defect may be filled to a suitable height with a filler (e.g., grout, filler particles, epoxy, resin) so as to provide a uniform, continuous backing for the seal to be formed. High areas of the conduit wall around the defect may be ground flat, or contoured to avoid sharp edges behind the repair system. The repair apparatus is preferably installed once the conduit wall surrounding the defect is suitably prepared.

In some embodiments, prior to positioning of the support member, an appropriate amount of lubricant (e.g., oil, vegetable based) is applied to the conduit wall around the defect site, and optionally along the circumference defined by the inner surface of the conduit wall, to facilitate positioning of the support member to suitably cover the defect. In various embodiments, the support member is an appropriately dimensioned metal sheet extended along the inner perimeter (e.g., circumference) of the conduit wall and positioned so as to cover the defect. In embodiments where the support member is a plate of sheet metal, an appropriate length of sheet metal may be measured and cut from a long roll of sheet metal to suit the particular region of the conduit that requires repair. As discussed previously, when suitably installed, portions of the support member may overlap with one another. In some embodiments, a shim, wedge material or adhesive bonding material may be optionally placed between overlapping portions of the support member.

Once the support member is placed in a suitable position, the sealing member is subsequently positioned over the support member. The inner surface of the support member may also be lubricated, for example, so as to facilitate an even distribution of pressure (e.g., arising from hydraulic forces) imposed by expansion of the retaining members, or to accommodate positioning of the sealing member relative to the support member. The sealing member may be pressed outwardly against the support member and the wall of the conduit to remove existing wrinkles, or the possibility of wrinkles, developed in the seal of the repair apparatus. Similar to the support member, the sealing member may be disposed over the defect and extend partially or entirely along the perimeter (e.g., circumference) defined by the inner surface of the conduit wall. In some embodiments, the sealing member may be appropriately measured and cut from a longer source of sealing material. Accordingly, portions of the sealing member may also overlap with one another.

Upon suitable placement of the sealing member over the support member, placed inward within the lumen of the conduit relative to the support member, one or more retaining members may be positioned appropriately over the sealing member. The retaining member(s) may provide an adequate amount of pressure to the sealing member so as to ultimately form an obstruction to fluid flow between the interior and exterior of the conduit. The inner surface of the sealing member where the retaining members will be placed may also be lubricated to facilitate suitable placement of and pressure application from the retaining members.

The retaining members may be provided as a single piece or as multiple separate members. In some embodiments, retaining members are positioned about equidistant on either side of the centerline of the width of the sealing member (e.g., approximately equidistant on either side from where the defect is located). In some embodiments, retaining members are positioned a minimum distance (e.g., at least 2 inches) from the edge of the defect. Depending on how the retaining members are measured and cut, the retaining members may extend over the sealing member and support member partially or entirely along the perimeter (e.g., circumference) defined by the inner surface of the conduit wall. In some embodiments, portions of each retaining member may overlap with one another.

As discussed above, a shim, or other thin and optionally tapered or wedged piece of material, may be inserted underneath a region of each retaining member. Such a shim may serve to protect the sealing member and also to provide adjustment for a more desirable fit between the sealing member and the retaining member prior to pressure application.

In some embodiments, once the retaining members are suitably positioned with respect to the sealing member and support member, the retaining members are expanded, for example, using a hydraulic expander. For instance, a hydraulic expander head may be placed into engagement with push tabs disposed on the retaining members. Push tabs may provide a suitable platform for the hydraulic expander to apply expansion pressure to the retaining members. The retaining members may then be radially expanded outwardly so as to generate an adequate amount of force for a seal to be formed between the sealing member and the inner surface of the conduit wall. A maximum applied pressure from the expander may be held for a suitable period of time (e.g., more than two minutes). In some embodiments, after the retaining members are each expanded, an appropriate period of time (e.g., 30 minutes or more) is allowed to pass, providing for material flow (creep) of the sealing member to occur. After the appropriate period of time passes, a subsequent expansion is performed for each of the retaining members. Accordingly, allowing for a suitable period of time to pass and re-expanding the retaining members into the sealing member may be repeated as many times as desired for the repair apparatus to be installed.

An appropriately sized shim or wedge may be inserted between overlapping portions of the retaining member. The shim or wedge maintains an interference fit so that the compressive force in the retaining member is preserved after the pressure application instrument is depressurized and removed from the defect site. In some embodiments, after an initial expansion of the retaining member, a wedge is inserted between the sealing member and retaining member, and then after re-expansion of the retaining member, an appropriately larger wedge is inserted between the sealing member and retaining member. Such a process may be performed for installation of each of the retaining members.

The amount of compressive force exerted on the conduit wall resulting from the outward radial expansion of the retaining members is not limited, though, in some embodiments, such a compressive force may be between about 100 psi and about 5000 psi. Once the repair apparatus is appropriately installed so that a suitable amount of residual pressure may be present to maintain the seal, the installation tool may be removed.

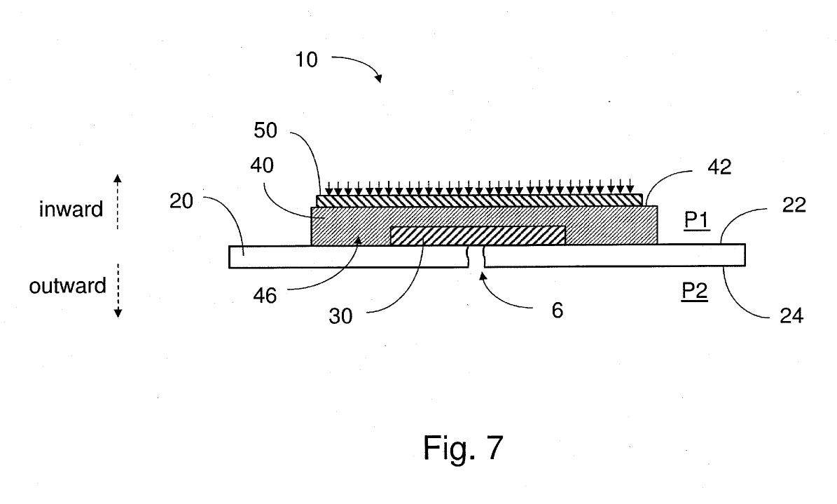

It can be appreciated that other arrangements of the repair apparatus are possible. FIGS. 7-9 illustrate various alterations of the embodiment shown in FIG. 2A that are within the scope of the present disclosure. In each embodiment, while arranged in a different manner, it can be appreciated that the sealing member 40 is still positioned along the periphery of the support member 30 so as to obstruct fluid flow between an outer surface of the support member and the inner surface 22 of the conduit. Thus, the repair apparatus functions to prevent leakage between the interior and the exterior of the conduit and also provides structural support to the repaired conduit. Appropriate methods may be used to install various embodiments of repair apparatuses described. For example, methods discussed above may be suitably altered depending on the overall structure of the repair apparatus.

FIG. 7 includes a repaired conduit 10 similar to that illustrated in FIG. 2A with the exception that the retaining member 50 extends substantially across the width of the sealing member 40. As such, rather than having four retaining members 50a, 50b, 60a, 60b positioned at particular locations with respect to the support member and the sealing member, the retaining member 50 extending across the width of the sealing member provides a continuous pressure throughout the width of the sealing member. Such an arrangement allows for the pressure to be distributed across the entire sealing member rather than at discrete locations along the sealing member. In some embodiments, such a distributed pressure arrangement alleviates the pressure that would exist at specific locations along the sealing member.

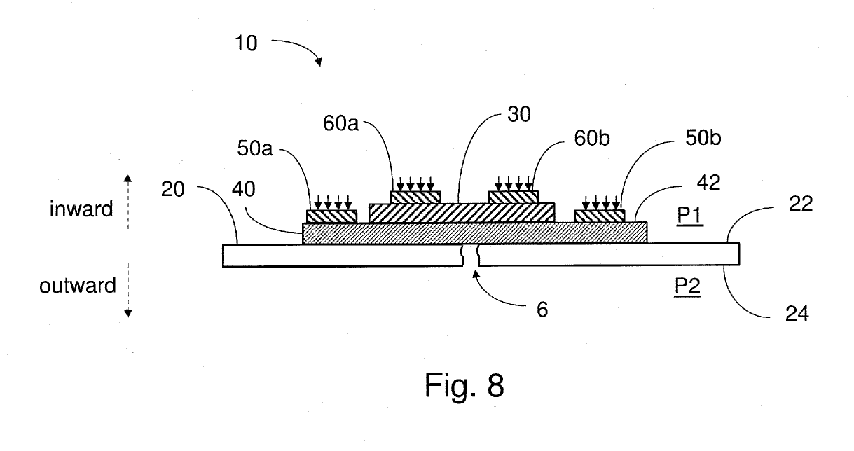

In some embodiments, a sealing member 40 is positioned in between the inner surface 22 of the wall and the support member 30. FIG. 8 illustrates a repaired conduit 10 similar to that illustrated in FIG. 2A except that the support member 30 and the sealing member 40 are interposed such that the sealing member is sandwiched between the conduit wall and the support member 30. Accordingly, a seal is formed so as to obstruct fluid flow between the interior and the exterior of the conduit, also providing structural support to the repair system.

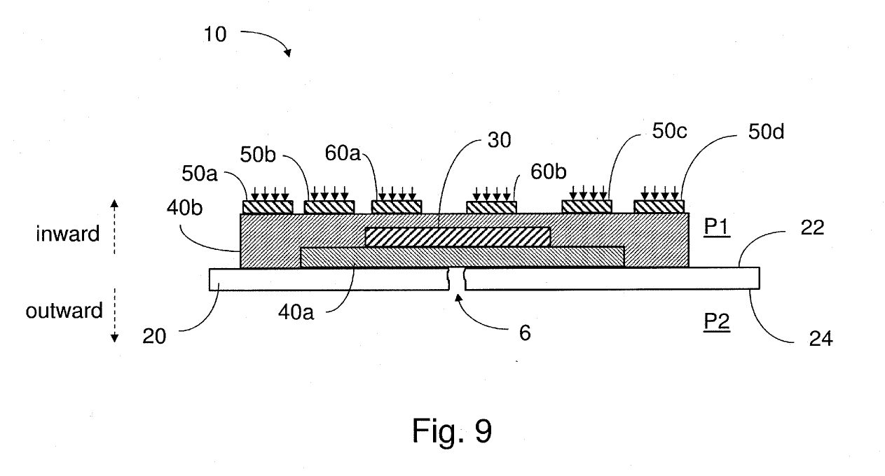

FIG. 9 depicts a repaired conduit 10 that incorporates two sealing members 40a, 40b disposed on either side of the support member 30. Positioned along an inner surface of the sealing member 40b are a number of retaining members 50a, 50b, 50c, 50d, 60a, 60b providing a suitable amount of compressive force for holding the repair apparatus in place. Similarly to the embodiments described above, a suitable seal is formed that obstructs fluid flow between the interior lumen and the exterior of the conduit. In addition, the presence of the support member 30 and its position relative to the defect provides additional structural integrity to the repaired conduit.

A number of considerations may be factored into the design and implementation of the repair apparatus (e.g., in accordance with the ANSI/AWWA C115/A21.15 Code) so as to ensure acceptable long term performance of the repaired conduit. Such considerations may include the effects of: a) the contact pressure between retaining members, sealing member, support member and the host conduit; b) the hoop stresses that arise in the host conduit due to loads incurred by the retaining member(s); c) the compressive stresses in the retaining member(s); d) the wall thicknesses for the host conduit based on resultant forces of the retaining member(s); e) thermal characteristics on the forces in the retaining member(s); f) contact forces between the sealing member and the conduit wall; g) hydrodynamic loads on the sealing member for flow conditions so that the seal is maintained; h) seismic loading conditions; i) abnormal loading conditions; j) external loads such as groundwater and other burdensome loads, as applicable; k) calculated loads on the support member, wall thicknesses; and 1) cyclic fatigue.

Further, with respect to the stability of the seal during installation and operation of the repair system, the following items may also be considered: a) buckling of the retaining members due to installation loads; b) tresses in the welds between the retaining member(s) and respective push tabs; c) differential thermal expansion between the sealing member and the host conduit; d) hydrodynamic loads; and e) other application specific design conditions. Such conditions consider the potential failure modes of the support member, the sealing member and the retaining members at installation and during long term operation.

### EXAMPLES

The following examples are intended to illustrate certain embodiments of the present invention, but are not to be construed as limiting and do not exemplify the full scope of the invention.

A repair apparatus similar to that shown above in FIGS. 3A-3C and 4 was installed in a conduit. A steel plate was positioned in contact with the conduit along its inner surface with the ends of the steel plate slightly overlapping with respect to one another. The steel plate had a thickness T₁ of between 0.0538 and 0.0658 inches and a width W₁ of 14.0 inches across. The diameter of the steel plate, when installed, was 30.4 inches. An EPDM gasket having ridges at its peripheral regions was placed over the steel plate with peripheral regions of the gasket positioned over and along the periphery of the steel plate. The gasket had a thickness T₂ of 0.30 inches, a width W₂ of the peripheral regions was 2.1 inches and a total width W₃ of the gasket was 21.5 inches. The diameter of the gasket, when installed, was 30.2 inches. Two retaining bands were positioned directly over the peripheral regions of the EPDM gasket and two retaining bands were positioned directly over the steel plate, disposed at least 2 inches laterally away from the defect. The retaining bands had a thickness T₃ of between 0.1775 and 0.2385 inches and a width W₄ of between 1.969 and 2.031 inches. Similar to that shown in FIGS. 6A and 6B, a 2 inch×6 inch shim was placed between the retaining band and the gasket. The retaining bands were then expanded with a hydraulic pressure expander. After expansion, a period of over 30 minutes was allowed to pass so that the gasket would equilibrate to the applied loading. The retaining bands were then re-expanded with the hydraulic pressure expander. Once fully expanded, a 2 inch wide wedge was inserted between the retaining bands. The diameter of the retaining bands when installed was 28.7 inches.

Table 1 below lists suitable expansion pressures for retaining bands with a hydraulic expander for bands made up of different materials and thicknesses.

TABLE 1
Examples of Hydraulic Expander Pressures for Various Retaining
Members

| | | Band Thickness (inches) | | | | |
|---|---|---|---|---|---|---|
| | High | | 304 | | | |
| CONDUIT | Expander | | Stain- | 316L | A36 | 1020 |
| SIZE | Pressure | | less | Stainless | Carbon | Carbon |
| (INCHES) | (psi) | AL6XN | Steel | Steel | Steel | Steel |
| 12 | 1100 | 1/8 | 1/8 | 1/8 | 1/8 | 1/8 |
| 12 | 1500 | 3/16 | 3/16 | 3/16 | 3/16 | 3/16 |
| 16 | 1500 | 1/8 | 1/8 | 1/8 | 1/8 | 1/8 |
| 16 | 2000 | 3/16 | 3/16 | 3/16 | 3/16 | 3/16 |
| 18 | 1500 | 1/8 | 1/8 | 1/8 | 1/8 | 1/8 |
| 18 | 2000 | 3/16 | 3/16 | 3/16 | 3/16 | 3/16 |
| 20 | 2500 | 3/16 | 3/16 | 3/16 | 3/16 | 3/16 |
| 20 | 3000 | 1/4 | 1/4 | 1/4 | 1/4 | 1/4 |
| 24 | 3200 | 3/16 | 3/16 | 3/16 | 3/16 | 3/16 |
| 24 | 3500 | 1/4 | 1/4 | 1/4 | 1/4 | 1/4 |
| 30 | 3200 | 3/16 | 3/16 | 3/16 | 3/16 | 3/16 |
| 30 | 3500 | 1/4 | 1/4 | 1/4 | 1/4 | 1/4 |
| 36 | 3500 | 3/16 | 3/16 | 3/16 | 3/16 | 3/16 |
| 36 | 3800 | 1/4 | 1/4 | 1/4 | 1/4 | 1/4 |
| 42 | 3500 | 3/16 | 3/16 | 3/16 | 3/16 | 3/16 |
| 42 | 3800 | 1/4 | 1/4 | 1/4 | 1/4 | 1/4 |
| 48 | 3800 | 3/16 | 3/16 | 3/16 | 3/16 | 3/16 |
| 48 | 4000 | 1/4 | 1/4 | 1/4 | 1/4 | 1/4 |
| 54 | 4000 | 3/16 | 3/16 | 3/16 | 3/16 | 3/16 |
| 54 | 4300 | 1/4 | 1/4 | 1/4 | 1/4 | |
| 60 | 4400 | 1/4 | 1/4 | 1/4 | 1/4 | |
| 72 | 4500 | 1/4 | 1/4 | 1/4 | 1/4 | |
| 78 | 4500 | 1/4 | 1/4 | 1/4 | 1/4 | |
| 84 | 4600 | 1/4 | 1/4 | 1/4 | 1/4 | |
| 96 | 4600 | 1/4 | 1/4 | 1/4 | 1/4 | |
| 108 | 4800 | 1/4 | 1/4 | 1/4 | 1/4 | |
| 120 | 4800 | 3/8 | 3/8 | 3/8 | 3/8 | |
| 138 | 4800 | 3/8 | 3/8 | 3/8 | 3/8 | |
| 216 | 5000 | 3/8 | 3/8 | 3/8 | 3/8 | |

The above aspects may be employed in any suitable combination as the present invention is not limited in this respect. Also, any or all of the above aspects may be employed in a conduit or piping arrangement; however, the present invention is not limited in this respect, as aspects of the invention may be employed with other systems. The repair apparatus of the present disclosure provides various advantages such as long term reliability (e.g., for over 50 years) and suitability to any usable conduit. The repair apparatus further provides flexibility which ensures that preventive maintenance and repairs of a conduit can be performed with relative ease (e.g., without any need for welding repairs or replacement of entire sections of a conduit to be done).

Having thus described several aspects of at least one embodiment of this invention, it is to be appreciated various alterations, modifications, and improvements will readily occur to those skilled in the art. Such alterations, modification, and improvements are intended to be part of this disclosure, and are intended to be within the spirit and scope of the invention. Accordingly, the foregoing description and drawings are by way of example only.

What is claimed is:

1. An apparatus for repairing a conduit comprising:
a support member constructed and arranged to be positioned along an inner surface of the conduit; and
a sealing member adapted to be positioned along at least a periphery of the support member so as to provide an obstruction to fluid flow between a portion of an outer surface of the support member and a portion of the inner surface of the conduit.

2. The apparatus of claim 1, wherein the support member comprises a sheet plate.

3. The apparatus of claim 1, wherein the support member substantially conforms to a shape defined by the inner surface of the conduit.

4. The apparatus of claim 1, wherein the sealing member is adapted to be positioned along an inner surface of the support member.

5. The apparatus of claim 1, wherein the support member is adapted to be positioned between the portion of the inner surface of the conduit and a portion of the sealing member.

6. The apparatus of claim 1, wherein the sealing member comprises an elastomeric material.

7. The apparatus of claim 1, further comprising at least one retaining member adapted to be positioned along an inner surface of the sealing member.

8. The apparatus of claim 7, wherein the at least one retaining member is adapted to apply pressure to the sealing member and the support member.

9. The apparatus of claim 7, wherein the at least one retaining member is constructed and arranged to extend along an entire circumference of the inner surface of the conduit.

10. The apparatus of claim 1, wherein the support member is resistant to corrosion.

11. A conduit assembly comprising:
a conduit having an inner surface defining a lumen of the conduit;
a support member disposed along the inner surface of the conduit; and
a sealing member disposed along at least a periphery of the support member so as to obstruct fluid flow between a portion of an outer surface of the support member and a portion of the inner surface of the conduit.

12. The conduit assembly of claim 11, wherein the support member comprises a sheet plate.

13. The conduit assembly of claim 11, wherein the support member substantially conforms to a shape defined by the inner surface of the conduit.

14. The conduit assembly of claim 11, wherein the support member extends along an entire circumference of the inner surface of the conduit.

15. The conduit assembly of claim 11, wherein the sealing member is disposed along an inner surface of the support member.

16. The conduit assembly of claim 11, wherein the support member is disposed between the portion of the inner surface of the conduit and a portion of the sealing member.

17. The conduit assembly of claim 11, wherein the sealing member comprises an elastomeric material.

18. The conduit assembly of claim 11, further comprising at least one retaining member disposed along an inner surface of the sealing member.

19. The conduit assembly of claim 18, wherein the at least one retaining member applies pressure to the sealing member and the support member.

20. The conduit assembly of claim 18, wherein the at least one retaining member extends along an entire circumference of the inner surface of the conduit.

21. The conduit assembly of claim 11, wherein the outer surface of the support member contacts the inner surface of a conduit.

22. A method of repairing a defect in a conduit comprising:
positioning a support member along an inner surface of the conduit; and
positioning a sealing member along at least a periphery of the support member so as to obstruct fluid flow between a portion of an outer surface of the support member and a portion of the inner surface of the conduit.

23. The method of claim 22, wherein positioning the support member comprises substantially conforming the support member to a shape defined by the inner surface of the conduit.

24. The method of claim 22, wherein positioning the sealing member comprises positioning the sealing member along an inner surface of the support member.

25. The method of claim 22, further comprising positioning at least one retaining member along an inner surface of the sealing member.

26. The method of claim 22, further comprising expanding the at least one retaining member so as to apply pressure to the sealing member and the support member.
